(19) United States
(12) Patent Application Publication
(10) Pub. No.: US 2025/0062992 A1
(43) Pub. Date: Feb. 20, 2025

(54) CONTROL APPARATUS, CONTROL METHOD AND PROGRAM

(71) Applicant: NIPPON TELEGRAPH AND TELEPHONE CORPORATION, Tokyo (JP)

(72) Inventor: Hideo TSUCHIYA, Tokyo (JP)

(21) Appl. No.: 18/724,376

(22) PCT Filed: Feb. 10, 2022
(86) PCT No.: PCT/JP2022/005330

§ 371 Date: Jun. 26, 2024

(51) Int. Cl. H04L 47/122; H04L 43/16

(52) U.S. Cl. CPC H04L 47/122; H04L 43/16

(57) ABSTRACT

Provided is a control device serving as a domain controller, including: a specification unit configured to, when the number of received packets of a first software router controlled by the domain controller exceeds a threshold value, specify a network slice having a maximum number of received packets among a plurality of network slices accommodated by one or more second software routers that are controlled by another domain controller and that transmit packets to the first software router; and a request unit configured to transmit, to the other domain controller, a request for limiting transmission of packets in the network slice specified by the specification unit, thereby efficiently avoiding a situation in which a software router becomes uncontrollable.

### TECHNICAL FIELD

The present invention relates to a control device, a control method, and a program.

### BACKGROUND ART

In the related art, in order to provide an end-to-end network slice extending over a plurality of business operators as a service, network slices between business operators are managed and operated on the basis of indicators such as bandwidth and delay (NPL 1).

Software routers, which are cost-effective and flexible, are used in parts connecting respective business operators or in networks of the respective business operators (NPL 1). When a plurality of network slices are configured on a single software router in accordance with requirements or the like, each network slice is logically divided, and the bandwidth is also clearly allocated (NPL 2).

In the related art, a domain controller installed in each business operator (domain) manages the bandwidth and delay of a software router and resources such as a CPU and a memory, operates and controls the software router, and maintains service quality (NPL 2).

### CITATION LIST

### Non Patent Literature

[NPL 1] Takuya Sato, Tomohiro Okada, Shunsuke Homma, Hidetaka Nishihara, “Network slicing technology that responds quickly to a wide range of requirements,” Information Network Study Group, NTT Technical Journal, April 2019, P20-21, Internet <URL:https://journal.ntt.co.jp/wp-content/uploads/2020/05/JN201904all.pdf>

[NPL 2] Tomohiro Okada, Takuya Sato, Hidetaka Nishihara “Network slicing technology—Aiming to build a new network that meets customer requirements in the 5G era,” NTT R&D Website, Internet <URL: https://www.rd.ntt/research/NW99-324.html>

### SUMMARY OF INVENTION

### Technical Problem

Since software routers perform packet processing using software, when receiving a large number of (short) packets (for example, when receiving a large number of packets transmitted from IoT terminals or user terminals due to simultaneous calls, etc.), a high load is generated even in a situation in which the bandwidth of the software router is small, and the service stops due to packet loss or the like. Furthermore, even if a large number of packets are transmitted from a specific network slice, this will affect all network slices on the same software router. Furthermore, when such a situation occurs, the software router may be unable to receive control from the domain controller due to the high load.

FIG. 1 is a diagram for describing a situation in which a software router becomes uncontrollable. In FIG. 1, an example is shown in which the following situation occurs.
(1) A large number of packets (traffic volume is small) are transmitted from UE in a slice 1. However, there is no problem with the processing and bandwidth of a software router A.
(2) A large number of packets from the slice 1 arrive at a software router B, and packets from slices 2 and 3 also arrive at the software router B (total traffic volume is within the bandwidth).
(3) The number of packets that have arrived at the software router B exceeds the number of packets that the software router B can process, resulting in a high load state. As a result, the slices 1, 2, and 3 become unavailable due to the large number of packets from the slice 1.
(4) There is no problem with the bandwidth of the software router B, which is managed by the domain controller, and therefore no alarm is generated, but the software router B is in a high load state and thus cannot be controlled by a domain controller B (silent failure).

Software router resources (bandwidth, delay, CPU, memory, etc.) are configured and managed through provisioning, but when trying to configure resources to increase the number of packets that can be processed, it is necessary to allocate excessive amounts of a CPU and a memory, resulting in surplus resources and division loss.

The present invention has been made in view of the above points, and an object of the present invention is to make it possible to efficiently avoid a situation in which a software router becomes uncontrollable.

### Solution to Problem

In order to achieve the above object, there is provided a control device serving as a domain controller, including: a specification unit configured to, when the number of received packets of a first software router controlled by the domain controller exceeds a threshold value, specify a network slice having a maximum number of received packets among a plurality of network slices accommodated by one or more second software routers that are controlled by another domain controller and that transmit packets to the first software router; and a request unit configured to transmit, to the other domain controller, a request for limiting transmission of packets in the network slice specified by the specification unit.

### Advantageous Effects of Invention

It is possible to efficiently avoid a situation in which the software router becomes uncontrollable.

### BRIEF DESCRIPTION OF DRAWINGS

FIG. 1 is a diagram for describing a situation in which a software router becomes uncontrollable.

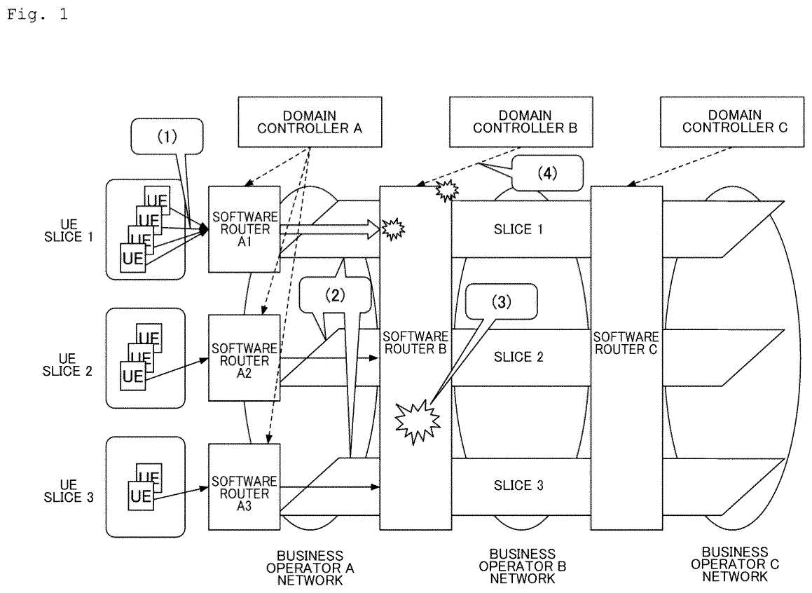

FIG. 2 is a diagram for describing a configuration example of a slice control system according to an embodiment of the present invention.

FIG. 3 is a diagram illustrating an example of a hardware configuration of a domain controller 10 according to the embodiment of the present invention.

FIG. 4 is a diagram illustrating an example of a functional configuration of the domain controller 10 and a software router 20 according to the embodiment of the present invention.

FIG. 5 is a sequence diagram for describing an example of a processing procedure executed in the slice control system.

FIG. 6 is a diagram illustrating an example of router information.

FIG. 7 is a diagram illustrating an example of router information to which a load factor has been added.

### DESCRIPTION OF EMBODIMENTS

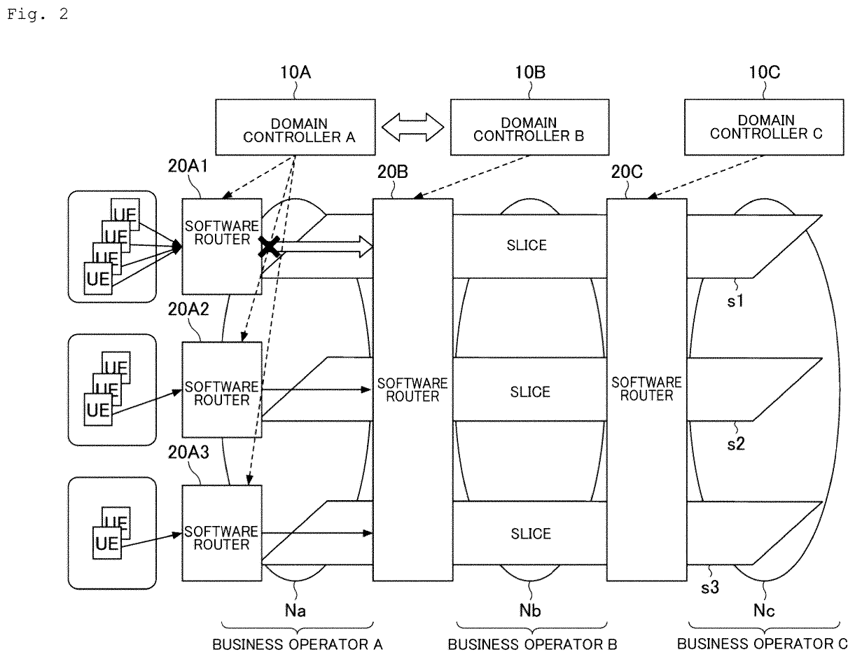

Embodiments of the present invention will be described below with reference to the drawings. FIG. 2 is a diagram for describing a configuration example of a slice control system according to an embodiment of the present invention. FIG. 2 illustrates an example in which three network slices s1 to s3 (hereinafter simply referred to as “slice s”) are configured across three domains, namely a network Na, a network Nb, and a network Nc of a business operator A, a business operator B, and a business operator C. Note that a network slice is a virtual network that is formed according to requirements and is achieved by the network slicing technology disclosed in NPL 1, NPL 2, and the like. The requirements include, for example, a start point node, an end point node, allowable delay, bandwidth, a period, and the like.

The business operator A operates a domain controller 10A. The domain controller 10A is a device (computer) that controls three software routers 20A1 to 20A3. The software router 20A1 accommodates the slice s1. The software router 20A2 accommodates the slice s2. The software router 20A3 accommodates the slice s3.

The business operator B operates a domain controller 10B. The domain controller 10B is a device (computer) that controls a software router 20B. The software router 20B accommodates the slices s1 to s3. That is, the slices s1 to s3 are bundled by the software router 20B. The software router 20B is an adjacent router of the software routers 20A1 to 20A3 for each slice s.

The business operator C operates a domain controller 10C. The domain controller 10C is a device (computer) that controls a software router 20C. The software router 20C accommodates the slices s1 to s3. The software router 20C is an adjacent router of the software router 20B for each slice s.

The software routers 20A1 to 20A3 each accommodate UEs (terminals) that communicate using the corresponding slices s, and transmit packets from each UE to the software router 20B. The software router 20B transmits each packet to the software router 20C.

Note that each software router 20 is provided, for example, in a computer located at a user base or a regional base (for example, a local city, etc.), and the computer serving as each domain controller 10 is located at a centralization base (for example, Tokyo, Osaka, etc.). Basically, each software router 20 is implemented by one computer. Further, each domain controller 10 is implemented by one computer. Therefore, in the software router 20 accommodating a plurality of slices s, the plurality of slices s share the same physical resource. When a certain centralization base also serves as a user base or a regional base, the computer in which the software router 20 is provided and the computer functioning as the domain controller 10 may be the same.

In the present embodiment, attention is paid to the domain controller 10B that controls the software router 20B for bundling the slices s1 to s3 and the domain controller 10A that controls the software routers 20A1 to 20A3 on the upstream side of the slices s. In the present embodiment, the domain controller 10A and the domain controller 10B can communicate via a network.

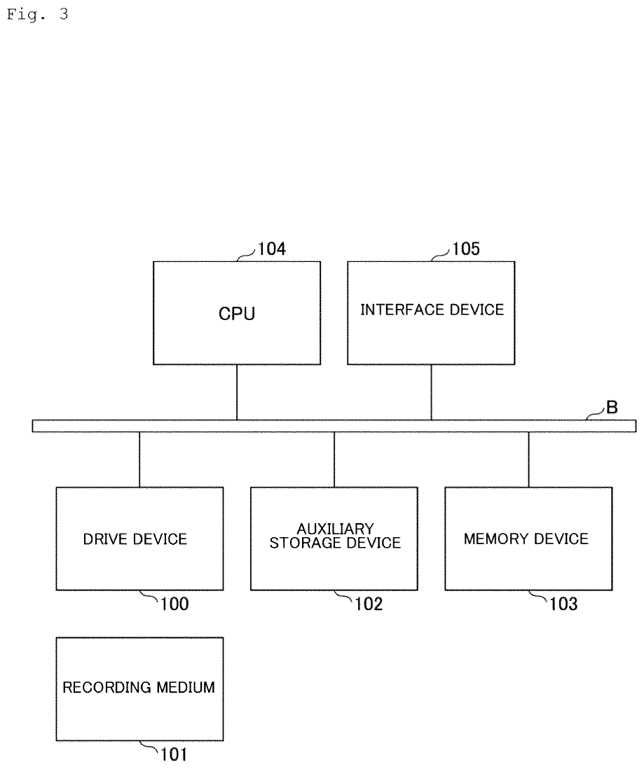

FIG. 3 is a diagram illustrating an example of a hardware configuration of the domain controller 10 according to the embodiment of the present invention. The domain controller 10 in FIG. 3 includes a drive device 100, an auxiliary storage device 102, a memory device 103, a CPU 104, an interface device 105, and the like, which are connected to each other by a bus B.

A program for implementing processing in the domain controller 10 is provided by a recording medium 101 such as a CD-ROM. When the recording medium 101 in which the program is stored is set in the drive device 100, the program is installed from the recording medium 101 to the auxiliary storage device 102 via the drive device 100. However, the program need not necessarily be installed from the recording medium 101, and may be downloaded from another computer via a network. The auxiliary storage device 102 stores the installed program and stores necessary files, data, and the like.

In a case where an activation instruction for the program is given, the memory device 103 reads out the program from the auxiliary storage device 102 and stores the program. The CPU 104 executes functions related to the domain controller 10 in accordance with the program stored in the memory device 103. The interface device 105 is used as an interface for connecting to a network.

Note that the computer in which the software router 20 is provided also has the same hardware configuration as that in FIG. 3.

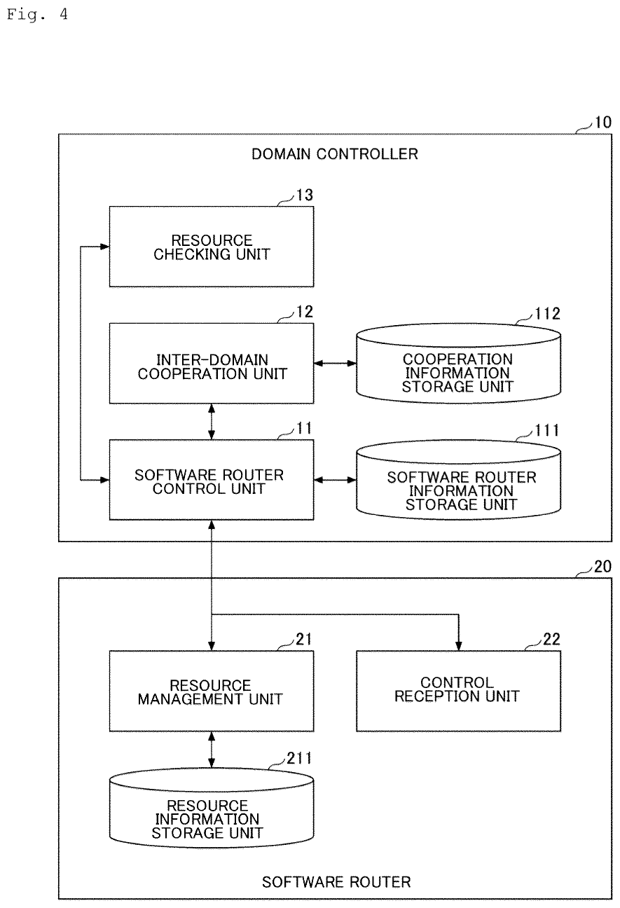

FIG. 4 is a diagram illustrating an example of a functional configuration of the domain controller 10 and a software router 20 according to the embodiment of the present invention.

In FIG. 4, the domain controller 10 includes a software router control unit 11, an inter-domain cooperation unit 12, and a resource checking unit 13. These units are implemented through processing that one or more programs installed in the domain controller 10 cause the CPU 104 to execute. The domain controller 10 also uses a software router information storage unit 111 and a cooperation information storage unit 112. These storage units can be implemented using, for example, the auxiliary storage device 102 or a storage device or the like that can be connected to the domain controller 10 via the network. Note that when referring to each unit of the domain controller 10A, an “a” is added to the end of the reference numeral. When referring to each unit of the domain controller 10B, a “b” is added to the end of the reference numeral.

On the other hand, the software router 20 includes a resource management unit 21 and a control reception unit 22. These units are implemented through processing that one or more programs installed on the computer in which the software router 20 is provided cause the CPU of the computer to execute. The software router 20 also includes a resource information storage unit 211. The resource information storage unit 211 can be implemented using, for example, an auxiliary storage device or a memory device of the computer.

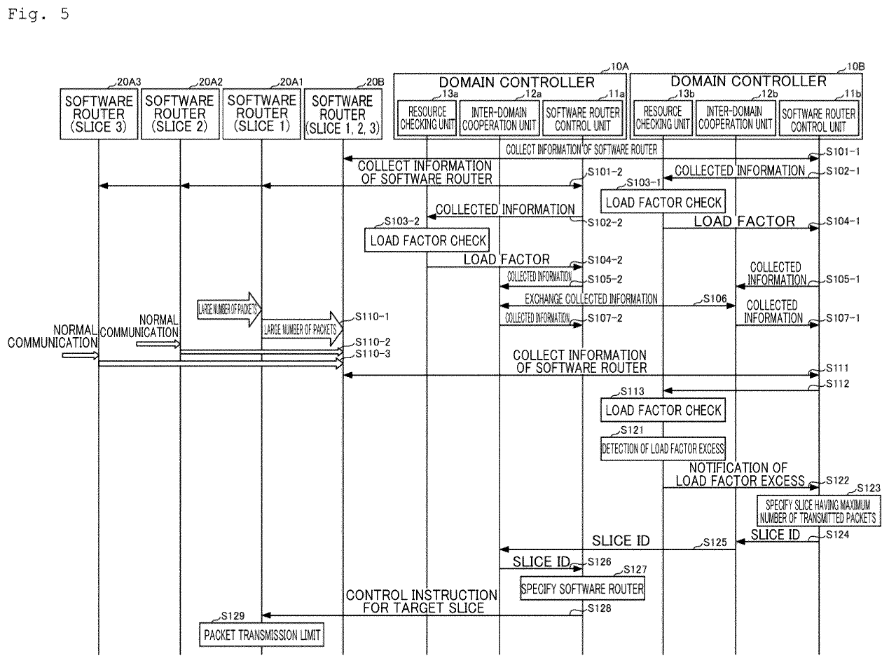

The processing procedure executed in the slice control system will be described below. FIG. 5 is a sequence diagram for describing an example of a processing procedure executed in the slice control system.

The software router control unit 11 of each domain controller 10 collects information regarding the state of the software router 20 (hereinafter referred to as “router information”) from the resource management unit 21 of each software router 20 controlled by the domain controller 10 at a plurality of timings (hereinafter referred to as “collection timings”), and stores the collected router information (hereinafter referred to as “collected information”) in the software router information storage unit 111. The plurality of timings may be periodic timings.

For example, when a certain collection timing arrives, the software router control unit 11b of the domain controller 10B collects router information from the software router 20B (S101-1), and the software router control unit 11a of the domain controller 10A collects information on each of the software routers 20A1 to 20A3 (S101-2). At this time, the software router control unit 11 of each domain controller 10 requests the resource management unit 21 of each software router 20 under the control of the domain controller 10 to transmit router information. Each resource management unit 21 performs calculation at a predetermined timing, such as periodically, and transmits a response including the router information stored in the resource information storage unit 211 to the software router control unit 11.

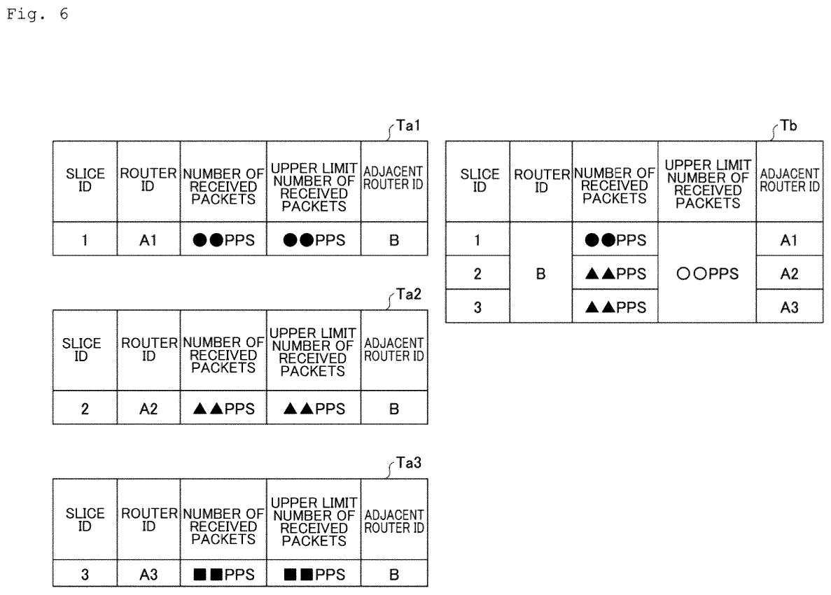

FIG. 6 is a diagram illustrating an example of router information. In FIG. 6, tables Ta1, Ta2, and Ta3 are examples of router information collected from the software routers 20A1, 20A2, and 20A3, respectively. A table Tb is an example of router information collected from the software router 20B.

Each piece of router information includes a slice ID, the number of received packets, and an adjacent router ID for each slice s accommodated by each software router 20, and includes a router ID and an upper limit number of received packets for each software router 20.

The slice ID is identification information of the slice s. In the present embodiment, the slice IDs of slices s1, s2, and s3 are 1, 2, and 3 in this order. The router ID is identification information of the software router 20. In the present embodiment, the router IDs of the software routers A1, A2, A3, and B are A1, A2, A3, and B in this order. In the upper limit number of received packets, the number of received packets is the number of received packets by the software router 20 per second in the slice s. The method for measuring the number of received packets depends on the specifications of the software router 20, but may be an average value over the last five minutes, for example. The upper limit number of received packets is the upper limit value of the number of received packets when the software router 20 is in a controllable state. The adjacent router ID is identification information of the software router 20 adjacent to the software router 20 in the slice s. Adjacency is the relationship of a transmission destination or a transmission source of a packet.

Subsequently, the software router control unit 11 of each domain controller 10 transmits the collected information to the resource checking unit 13 of its own domain controller 10 (S102-1, S102-2). The resource checking unit 13 of each domain controller 10 calculates a load factor of each software router 20 under control on the basis of the received router information, and checks whether or not the load factor exceeds a threshold value (S103-1, S102-2). The load factor is the ratio of the total number of received packets (in the case of accommodating a plurality of slices s) to the upper limit number of received packets. Therefore, the load factor of a certain software router 20 can be calculated by dividing the total number of received packets of the router information of the software router 20 by the upper limit number of received packets. Further, the threshold value is a value lower than the load factor at which the domain controller 10 becomes unable to control the software router 20. For example, 90(%) may be set as the threshold value.

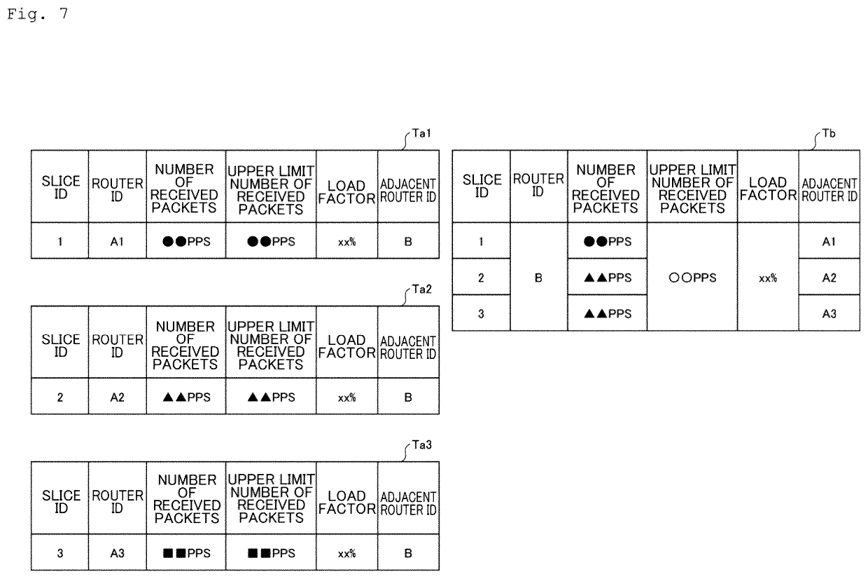

Subsequently, the resource checking unit 13 of each domain controller 10 transmits the load factor calculated for each software router 20 to the software router control unit 11 of its own domain controller 10 (S104-1, S104-2). Upon receiving the load factor of each software router 20, the software router control unit 11 of each domain controller 10 records (adds) the load factor in the router information of the software router 20 corresponding to the load among the router information stored for each software router 20 in the software router information storage unit 111. As a result, the router information of each software router 20 is as illustrated in FIG. 7, for example.

Subsequently, the software router control unit 11 of each domain controller 10 transmits the collected information to the inter-domain cooperation unit 12 of its own domain controller 10 (S105-1, S105-2).

Subsequently, the inter-domain cooperation unit 12 of each domain controller 10 exchanges the collected information by transmitting the collected information received from the software router control unit 11 of its own domain controller 10 to the inter-domain cooperation unit 12 of another domain controller 10 (S106). Information (IP address, etc.) on the domain controller 10 that is the exchange partner (cooperation partner) is stored in the cooperation information storage unit 112. Basically, when the slices s accommodated by the software router 20 under control of one of two adjacent domain controllers 10 are merged (bundled) at the software router 20 under control of the other domain controller 10, the two domain controllers 10 are mutual exchange partners. In the present embodiment, the domain controller 10A and the domain controller 10B are mutual exchange partners.

Upon receiving the collected information of the other domain controller 10, the inter-domain cooperation unit 12 of each domain controller 10 transmits the collected information to the software router control unit 11 of its own domain controller 10 (S107-1, S107-2). The software router control unit 11 of each domain controller 10 stores the received collected information in the software router information storage unit 111.

The above-mentioned operation is repeatedly executed at each collection timing.

Thereafter, when a large number of packets are generated in the slice s1 of the software router 20A1, software router 20B receives the large number of packets from the slice s1 of the software router 20A1 (S110-1). The software router 20B further receives packets of normal communication from each slice s of the software routers 20A2 and 20A3 (S110-2, S110-3).

At the subsequent collection timing, the software router control unit 11b of the domain controller 10B collects the router information of the software router 20B (S111), and transmits the router information to the resource checking unit 13b of the domain controller 10B (S112). In this case, when the resource checking unit 13b compares the load factor of the router information with the threshold value (S113), it detects that the load factor exceeds the threshold value (S121).

Therefore, the resource checking unit 13b transmits a notification of the load factor excess to the software router control unit 11b (S122). In response to the notification, the software router control unit 11b acquires, from the software router information storage unit 111b, router information of each software router 20 (hereinafter, each is referred to as an “adjacent router”) of another domain controller 10 related to the adjacent router ID of the router information (table Tb in FIG. 7) corresponding to the software router 20B stored in the software router information storage unit 111b. In the present embodiment, router information of each of the software routers 20A1 to 20A3 is acquired. Although not illustrated in FIG. 5, router information is exchanged between the domain controller 10A and the domain controller 10B at the collection timing of step S111 as well. Therefore, here, the latest router information exchanged at the last collection timing is acquired for each adjacent router. On the basis of the acquired router information, the software router control unit 11b specifies the slice s that transmits the maximum number of packets to the software router 20B among the slices s accommodated by adjacent routers (S123). Whether or not the maximum number of packets is being transmitted can be determined on the basis of whether or not the number of received packets is the maximum. Here, the slice s1 (slice s with slice ID=1) of the software router 20A1 is specified.

Subsequently, the software router control unit 11b transmits the specified slice ID (hereinafter referred to as a “target slice ID”) to the inter-domain cooperation unit 12b (S124). The inter-domain cooperation unit 12b transmits the target slice ID and a request for limiting the transmission of packets in a slice s related to the target slice ID (hereinafter referred to as a target slice s”) to the inter-domain cooperation unit 12a of the domain controller 10A, which is the exchange partner of the router information related to the target slice ID (S125).

Upon receiving the target slice ID, the inter-domain cooperation unit 12a transmits the target slice ID to the software router control unit 11a of the domain controller 10A (S126). The software router control unit 11a refers to the router information collected from the software routers 20A1 to 20A3, which is stored in the software router information storage unit 111a, and specifies the software router 20 (hereinafter referred to as a “target router”) that accommodates the target slice s related to the target slice ID (S127). Here, the software router 20A1 is specified as the target router.

Subsequently, the software router control unit 11a transmits the target slice ID and an instruction to limit packet transmission in the target slice s to the software router 20A1, which is the target router (S128). The control reception unit 22 of the software router 20A1 limits packet transmission in the slice s1, which is the target slice s, in response to the control instruction (S129). For example, packet transmission may be interrupted (stopped), or the number of transmitted packets may be limited.

As described above, according to the present embodiment, when the number of received packets of a software router 20 controlled by a certain domain controller 10 exceeds a threshold value, a network slice having the maximum number of received packets is specified among a plurality of network slices accommodated by one or more other software routers 20 that are controlled by another domain controller 10 and that transmit packets to the software router 20, and a request for limiting transmission of packets in the specified network slice is transmitted to the other domain controller 10. As a result, it is possible to reduce the need for allocation of excessive amounts of a CPU and a memory in order to increase the upper limit of the number of received packets. Therefore, it is possible to efficiently avoid a situation in which the software router becomes uncontrollable. In other words, in an end-to-end network slice extending over a plurality of business operators, it is possible to avoid a high load state on the software router 20 due to mass transmission due to a virus infection of a user terminal or an IoT terminal of a specific network slice, simultaneous calls due to a power outage, etc., and avoid the influence on normal communication of other network slices. Further, by configuring a plurality of network slices with a single software router 20, the service provider can also provide cost-effective and reliable network slices.

Note that in the present embodiment, the domain controller 10 is an example of a control device. The software router control unit 11 is an example of a specification unit. The inter-domain cooperation unit 12 is an example of a request unit and a reception unit. The software router 20B is an example of a first software router. The software router 20A is an example of a second software router.

Although the embodiments of the present invention have been described in detail above, the present invention is not limited to these particular embodiments, and various modifications and changes are possible within the scope of the gist of the present invention described in the claims.

### REFERENCE SIGNS LIST

10 Domain controller
11 Software router control unit
12 Inter-domain cooperation unit
13 Resource checking unit
20 Software router
21 Resource management unit
22 Control reception unit
100 Drive device
101 Recording medium
102 Auxiliary storage device
103 Memory device
104 CPU
105 Interface device
111 Software router information storage unit
112 Cooperation information storage unit
211 Resource information storage unit
B Bus

1. A control device serving as a domain controller, comprising:
processing circuitry configured to
specify, when the number of received packets of a first software router controlled by the domain controller exceeds a threshold value, a network slice having a maximum number of received packets among a plurality of network slices accommodated by one or more second software routers that are controlled by another domain controller and that transmit packets to the first software router; and
transmit, to the other domain controller, a request for limiting transmission of packets in the specified network slice.

2. The control device according to claim 1,
wherein the processing circuitry is further configured to
receive the number of received packets of the plurality of network slices collected from the second software router by the other domain controller; and
specify a network slice having a maximum number of received packets received by the processing circuitry.

3. The control device according to claim 2, wherein the processing circuitry is further configured to
receive the number of received packets at a plurality of timings, and
specify a network slice having a maximum number of received packets received by the processing circuitry at the plurality of timings.

4. A control method executed by a computer serving as a domain controller, the method comprising:
specifying, when the number of received packets of a first software router controlled by the domain controller exceeds a threshold value, a network slice having a maximum number of received packets among a plurality of network slices accommodated by one or more second software routers that are controlled by another domain controller and that transmit packets to the first software router; and
transmitting a request for limiting transmission of packets in the network slice specified in said specifying to the other domain controller.

5. The control method according to claim 4, further comprising:
receiving, by the computer, the number of received packets of the plurality of network slices collected from the second software router by the other domain controller,
wherein a network slice having a maximum number of received packets received in said receiving is specified in said specifying.

6. The control method according to claim 5, wherein
the number of received packets at a plurality of timings is received in said receiving, and
a network slice having a maximum number of received packets received in said receiving at the plurality of timings is specified in said specifying.

7. A non-transitory computer-readable recording medium storing a program for causing a computer serving as a domain controller to execute a process, the process comprising:
specifying, when the number of received packets of a first software router controlled by the domain controller exceeds a threshold value, a network slice having a maximum number of received packets among a plurality of network slices accommodated by one or more second software routers that are controlled by another domain controller and that transmit packets to the first software router; and
transmitting a request for limiting transmission of packets in the network slice specified in said specifying to the other domain controller.
